(19) United States
(12) Patent Application Publication
(10) Pub. No.: US 2010/0219056 A1
(43) Pub. Date: Sep. 2, 2010

(54) BUTTON ASSEMBLY AND DIGITAL CAMERA HAVING THE SAME

(75) Inventor: Ji-myong An, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/702,499

(22) Filed: Feb. 9, 2010

(30) Foreign Application Priority Data
Feb. 27, 2009 (KR) 10-2009-0017134

(51) Int. Cl. H01H 25/00

(52) U.S. Cl. 200/337

(57) ABSTRACT

A button assembly and a digital camera having the same include a key button, a first contact point switch that generates a switching signal when the key button slides, and a third contact point switch that generates a switching signal when the key button is pressed. Accordingly, it is possible to easily manipulate a camera and perform an associated set of operations by providing one integrated button that replaces a plurality of buttons.

### CROSS-REFERENCE TO RELATED PATENT APPLICATION

This application claims the priority benefit of Korean Patent Application No. 10-2009-0017134, filed on Feb. 27, 2009, in the Korean Intellectual Property Office, the disclosure of which is incorporated herein in its entirety by reference.

### BACKGROUND

1. Field of the Invention

The present invention relates to a button assembly and a digital camera having the same, and more particularly, to a button assembly in which one integrated button is used instead of a plurality of buttons in order to facilitate user manipulation and to perform an associated set of operations in a simplified manner, and a digital camera having the button assembly.

2. Description of the Related Art

As camera functions become more numerous, a user interface (UI) via which user command is input becomes complicated. Recently, research has been conducted into developments in user interfaces in order to facilitate user manipulation and to improve the external design of a product.

In general, in a camera, a large number of buttons, e.g., a power button, a shutter-release button, and a play button, are separately mounted, and therefore, a user is inconvenienced in that the user has to manipulate these buttons individually. For example, the user turns on the camera using the power button, performs a shooting operation by finding and pressing the shutter-release button, and checks a captured image by pressing the play button after completing the shooting operation.

Also, a large number of elements and a large number of assembly processes are necessary to manufacture the above buttons, thus increasing manufacturing costs. In particular, a slim camera does not have a space enough to accommodate a plurality of buttons, which may prevent desired design of the exterior of the camera.

### SUMMARY

Embodiments of the present invention include a button assembly in which one integrated button is used instead of a plurality of buttons in order to facilitate user manipulation of a device and to perform an associated set of operations in a simplified manner, and a digital camera having the button assembly.

According to an aspect of the present invention, a button assembly for a camera includes a key button, a first contact point switch that generates a switching signal according to sliding of the key button, and a third contact point switch that generates a switching signal according to pressing of the key button.

The button assembly may further include a first linkage device that is disposed between the key button and the first contact point switch and converts sliding of the key button into pressing of the first contact point switch.

The first linkage device may include a moving part comprising inclined planes on which the key button slides, and which is pressed downward when the key button slides, and a pressing part that presses the first contact switch while the moving part is pressed.

The key button may slide to be moved from a first position to a second position, and the first contact point switch may be disposed adjacent to the first position.

The button assembly may further include a second contact point switch that generates a switching signal according to sliding of the key button, the second contact point switch being disposed adjacent to the second position.

The button assembly may further include a second linkage device that is disposed between the key button and the second contact point switch and converts sliding of the key button into pressing of the second contact point switch.

The second linkage device may include a moving part comprising an inclined plane on which the key button slides, and which is pressed downward when the key button slides, and a pressing part that presses the second contact point switch while the moving part is pressed.

The third contact point switch may be disposed between the first and second contact point switches.

The first, second, and third contact point switches may function as a power button, a play button, and a shutter-release button, respectively.

The key button may include a button unit that is pressed by a user, an elastic body that forces the button unit to be elastically biased upward, and a protrusion pin that extends from the button unit and presses the third contact point switch when the user presses the button unit.

An assembly unit may extend on opposite sides of the key button to cover an assembly hole formed along a direction in which the key button slides.

According to another aspect of the present invention, a button assembly for a camera includes a key button, a guide panel that guides sliding of the key button and defines movement of the key button from a first position to a second position, first and second contact point switches that are disposed adjacent to the first and second positions, respectively, and that generate a switching signal according to sliding of the key button, and a third contact point switch that is disposed between the first and second contact point switches, and that generates a switching signal according to pressing of the key button.

The button assembly may further include a first linkage device that is disposed between the key button and the first contact point switch and converts sliding of the key button into pressing of the first contact point switch.

The button assembly may further include a second linkage device that is disposed between the key button and the second contact point switch and converts sliding of the key button into pressing of the second contact point switch.

The key button may include a button unit that is pressed by a user, an elastic body that forces the button unit to be elastically biased upward, and a protrusion pin that extends from the button unit and presses the third contact point switch when the user presses the button unit.

According to another aspect of the present invention, a digital camera includes a key button, a guide panel that guides sliding of the key button and defines movement of the key button from a first position to a second position, first and second contact point switches that are disposed adjacent to the first and second positions, respectively, and that generate a switching signal according to sliding of the key button, and a third contact point switch that is disposed between the first and second contact point switches, and that generates a switching signal according to pressing of the key button.

The digital camera may further include a digital signal processor that controls an associated set of operations being respectively linked to the first, second, and third contact point switches, in response to the switching signals.

The digital camera may further include a first linkage device that is disposed between the key button and the first contact point switch and converts sliding of the key button into pressing of the first contact point switch.

The digital camera may further include a second linkage device that is disposed between the key button and the second contact point switch and converts sliding of the key button into pressing of the second contact point switch.

The key button may include a button unit that is pressed by a user, an elastic body that forces the button unit to be elastically biased upward, and a protrusion pin that extends from the button unit and presses the third contact point switch when the user presses the button unit.

### BRIEF DESCRIPTION OF THE DRAWINGS

The above and other features and advantages of the present invention will become more apparent by describing in detail exemplary embodiments thereof with reference to the attached drawings in which:

FIGS. 1 through 3 are perspective views of a button assembly that are provided to explain operations according to the location of a key button, according to an embodiment of the present invention;

FIG. 4 is a perspective view of a first linkage device of the button assembly of FIGS. 1 to 3;

FIG. 5 is a perspective view of a second linkage device of the button assembly of FIG. 2;

FIG. 6 illustrates a state in which the key button of the button assembly of FIG. 3 is disassembled, according to an embodiment of the present invention;

FIG. 7 illustrates a state in which the key button of the button assembly of FIG. 3 is assembled, according to an embodiment of the present invention; and

FIG. 8 is a block diagram illustrating overall construction of a digital camera according to an embodiment of the present invention.

### DETAILED DESCRIPTION

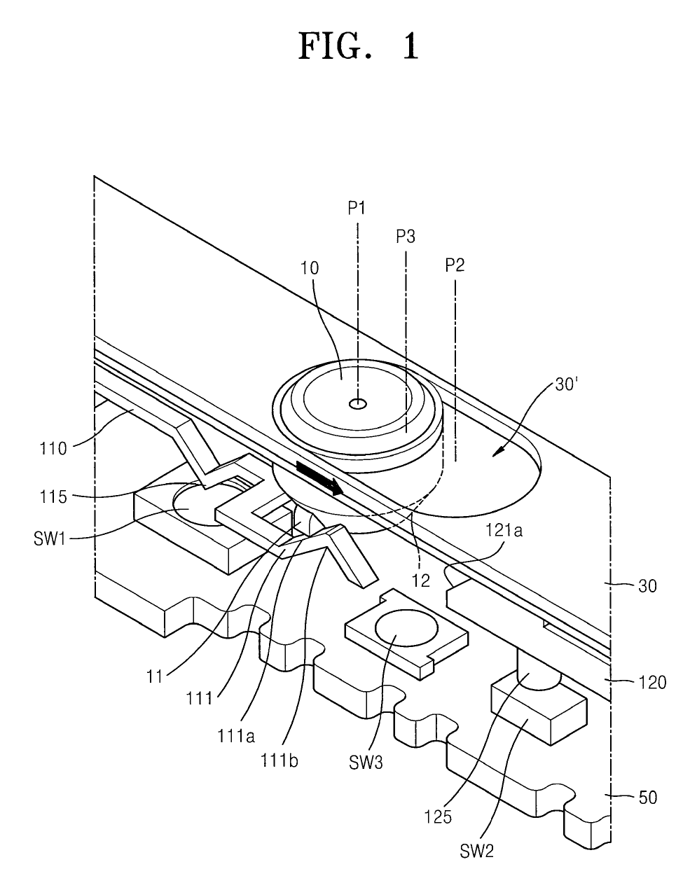

Hereinafter, exemplary embodiments of a button assembly for a digital camera and a digital camera having the same will be described with reference to the accompanying drawings. FIGS. 1 through 3 are perspective views of a button assembly that are provided to explain operations according to the location of a key button, according to an embodiment of the present invention. Referring to FIGS. 1 to 3, the button assembly includes a key button 10 and a guide panel 30. The key button 10 may slide while being stroked from a first position P1 to a second position P2 and may be pressed downward. The guide panel 30 is combined with the key button 10 by inserting the key button 10 into the guide panel 30, and guides the sliding of the key button 10. One or more contact point switches SW1, SW2, and SW3 are arranged below the guide panel 30 to be switched on or off by manipulating the key button 10. For example, the first to third contact point switches SW1, SW2, and SW3 may be mounted on different locations on a printed circuit board (PCB) 50.

In the guide panel 30, an assembly hole 30′ is formed and is through which the key button 10 is inserted into the guide panel 30. A direction in which the assembly hole 30′ extends defines the sliding and stroking of the key button 10. The key button 10 may be moved to the first position P1, the second position P2, or a third position P3 that is disposed between the first and second positions P1 and P2 within the assembly hole 30′ in order to turn on or off the first to third contact point switches SW1, SW2, and SW3.

The first to third contact point switches SW1, SW2, and SW3, which are turned on or off by manipulating the key button 10, may be directly pressed via the key button 10 or some thereof may be indirectly pressed via first and second linkage devices 110 and 120. If the first to third contact point switches SW1, SW2, and SW3 are physically touched, an electrical path is formed therein to generate an “ON/OFF” change signal. Specific functions may be allocated to the first to third contact point switches SW1, SW2, and SW3. The first to third contact point switches SW1, SW2, and SW3 may each be used as a function button for calling a function assigned thereto. For example, the first to third contact point switches SW1, SW2, and SW3 may function as a power button, a play button, and a shutter-release button, respectively.

Referring to FIG. 1, the first linkage device 110 may be disposed between the key button 10 and the first contact point switch SW1. The first linkage device presses the first contact point switch SW1 when a user slides the key button 10 to and from the first position P1. The first linkage device 110 includes a pair of moving parts 111 and a pressing part 115. Each of the moving parts 111 includes inclined planes 111a that may contact the key button 10 while the key button 10 is sliding on the inclined planes 111a and be pressed downward. The pressing part 115 protrudes to be pointed toward the first contact point switch SW1, and when the moving parts 111 are pressed downwards by the key button 10, presses the first contact point switch SW1 to turn on or off the first contact point switch SW1. When the key button 10 moves within the assembly hole 30′ in a sliding manner, the key button 10 may contact the incline planes 111a of the moving parts 111 and press the first linkage device 110 downward. Then, the pressing part 115 of the first linkage device 110 presses the first contact point switch SW1, thus turning the switch SW1 on or off. The key button 10 includes a protrusion 11 that may contact the first linkage device 110. The protrusion 11 may extend from sides of the key button 10 to be opposite to each other.

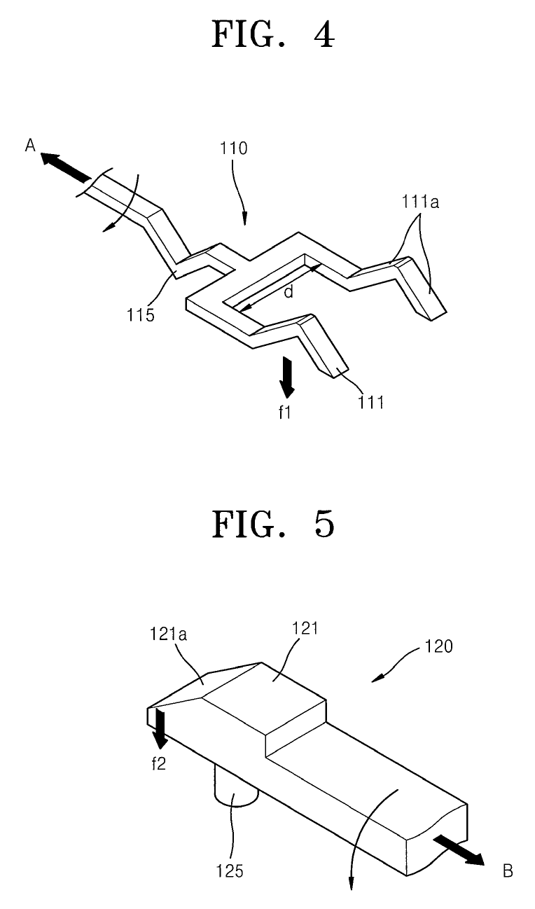

FIG. 4 is a perspective view of the first linkage device 110 of the button assembly illustrated in FIGS. 1 to 3. Referring to FIG. 1, the first linkage device 110 may have the form of a cantilever having one fixed end that extends in a direction A and free ends, e.g., the moving parts 111 that contact the key button 10. For example, the first linkage device 110 includes the pressing part 115 and the moving parts 111. The pressing part 115 protrudes downward to be bent in a ‘V’ shape while facing the first contact point switch SW1. The moving parts 111 branch out from an end of the pressing part 115, extend in parallel while being spaced apart a distance d from each other in order to receive the key button 10, and are bent in a ‘V’ shape. When the moving parts 111 contact the protrusions 11, which extend from opposite sides of the key button 10, pressure is applied to each of the moving parts 111 equally in a downward direction. The key button 10 slides along the inclined planes 111a pressing the moving parts 111 downward at a pressure f1, and the first linkage device 110 is bent downward with respect to the fixed end thereof. Then, the pressing part 115 presses the first contact point switch SW1 to turn on or off the first contact point switch SW1.

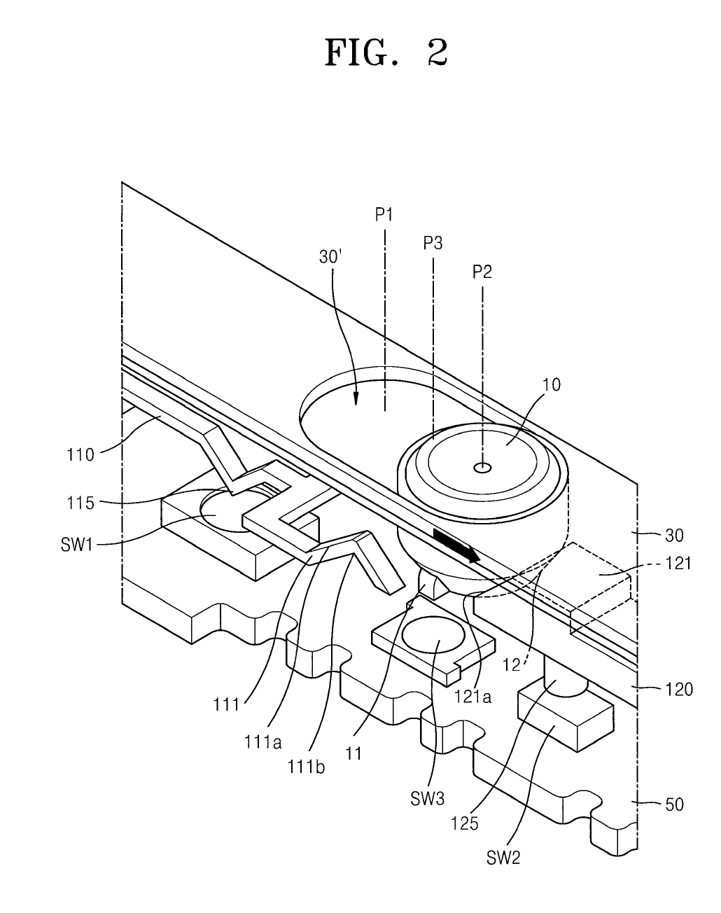

Referring to FIG. 2, the second linkage device 120 is disposed between the key button 10 and the second contact point switch SW2. The second linkage device presses the second contact point switch SW2 when a user slides the key button 10 to the second position P2. The second linkage device 120 includes a moving part 121 and a pressing part 125. The moving part 121 includes an inclined plane 121a that may contact the key button 10 while the key button 10 is sliding on the inclined plane 121a and may be pressed downward. The pressing part 125 protrudes facing the second contact point switch SW2, and when the moving part 121 is pressed downwards by the key button 10, presses the second contact point switch SW2 to turn on or off the second contact point switch SW2. The key button 10 is moved along the assembly hole 30′ in a sliding manner, slides while contacting the inclined moving part 121 and then presses the second linkage device 120 downward. Then, the pressing part 125, which is opposite to the moving part 121, presses the second contact point switch SW2 to turn on or off the second contact point switch SW2. The key button 10 may further include a contact plane 12 that is inclined to be complementary with the inclined plane 121a of the moving part 121 so that the contact plane 12 can contact the inclined plane 121a.

FIG. 5 is a perspective view of the second linkage device 120 of the button assembly of FIG. 2. Referring to FIG. 5, the second linkage device 120 may have the form of a cantilever having one fixed end that extends in a direction B and a free end, e.g., the moving part 121 that contacts the key button 10. For example, the second linkage device 120 includes the moving part 121 and the pressing part 125. The key button 10 slides along the inclined plane 121a to contact the moving part 121. The pressing part 125 protrudes downward while facing the second contact point switch SW2. When the key button 10 slides along the inclined plane 121a, the key button 10 presses the moving part 121 downward under pressure f2 and the pressing part 125, which is opposite to the moving part 121, presses the second contact point switch SW2, thus turning on or off the switch SW2.

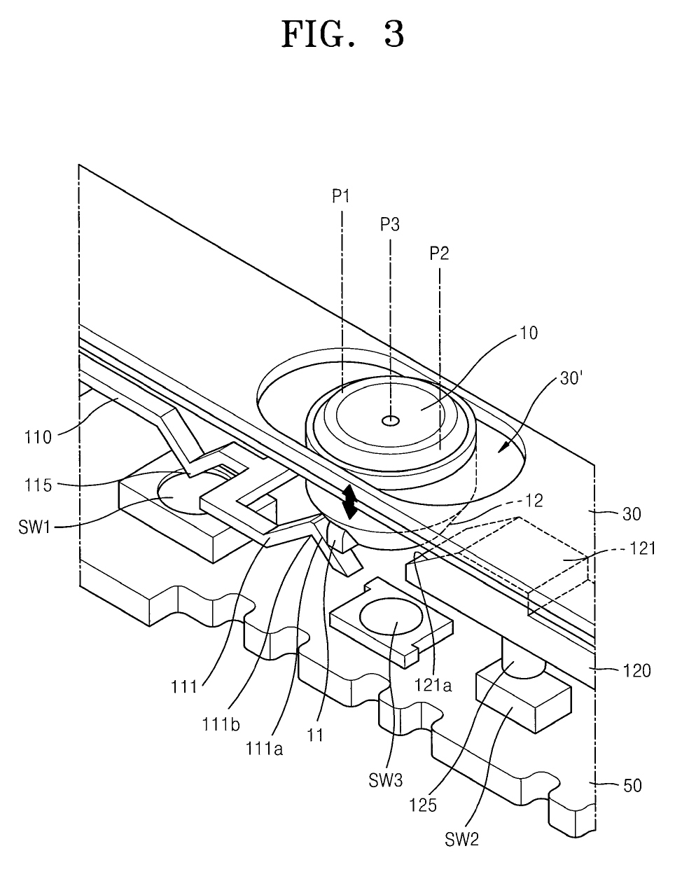

As illustrated in FIGS. 1 and 2, the first linkage device 110 is disposed between the key button 10 and the first contact point switch SW1 and the second linkage device 120 is disposed between the key button 10 and the second contact point switch SW2. Thereby, sliding of the key button 10 may press the first or second contact point switches SW1 and SW2. Referring to FIG. 3, the third contact point switch SW3 facing the position P3 in the center of the assembly hole 30′ may be turned on by directly pressing the key button 10 at the position P3, without use of an additional linkage device. The key button 10 is disposed right above the third contact point switch SW3 at the third point P3 in the assembly hole 30′. A user may turn on the third contact point switch SW3 by pressing the key button 10. For example, the third contact point switch SW3 that functions as a shutter-release button may be pressed in order to perform a shooting operation of the digital camera. The key button 10 may be used as a push button that presses the third contact point switch SW3 when the user presses the key button 10 downward, and elastically returns upward to the original position to be separated from the third contact point switch SW3 when the user ends the pressing of the key button 10.

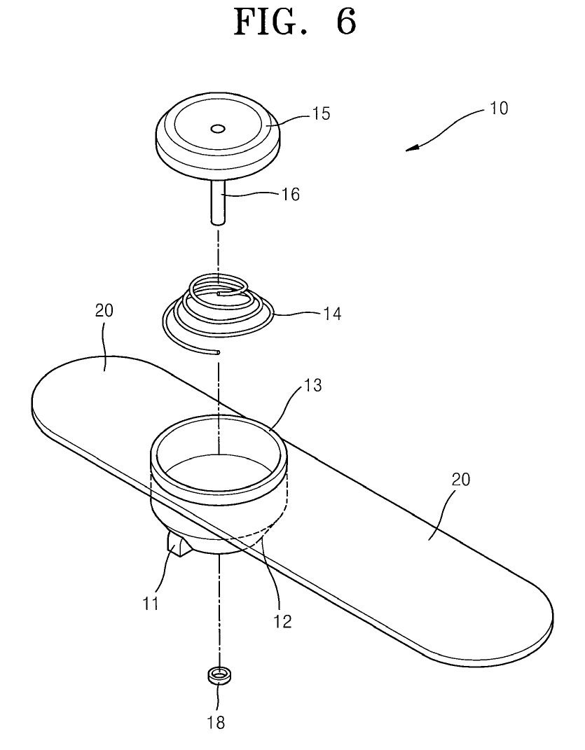

FIG. 6 illustrates a state in which the key button 10 of the button assembly of FIG. 3 is disassembled, according to an embodiment of the present invention. Referring to FIG. 6, the key button 10 includes a button holder 13 in which an upper portion is open and a hole is formed in a lower portion, an elastic body 14, and a disk type button unit 15 placed in the button holder 13. For example, the key button 10 may be assembled by placing the button unit 15 in the button holder 13 such that a protrusion pin 16 extending from the button unit 15 is inserted into the hole in the button holder 13 and then interlocking the protrusion pin 16 to the button holder 13 via a washer 18. When the button unit 15 is pressed downward, the protrusion pin 16 presses the third contact point switch SW3 illustrated in FIG. 3, thus turning on or off the third contact point switch SW3. When the pressing of the button unit 15 has ended, the protrusion pin 16 returns upward to the original position due to an elastic restitution force and is thus separated from the third contact point switch SW3.

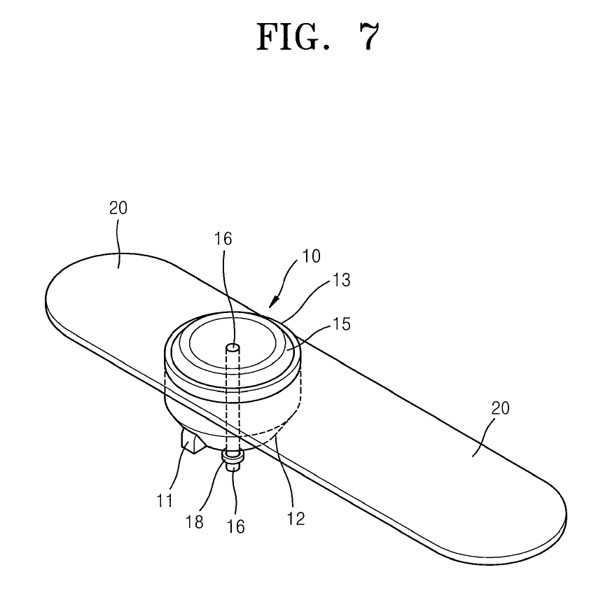

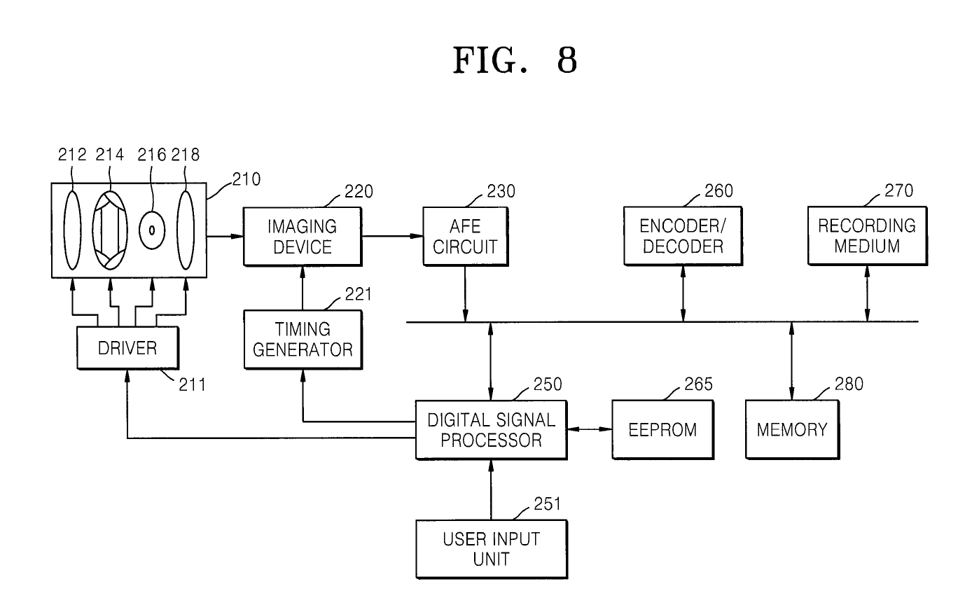

FIG. 7 illustrates a state in which the key button 10 of the button assembly of FIG. 3 is assembled, according to an embodiment of the present invention. Referring to FIG. 7, an assembly unit 20 may extend from opposite sides of the key button 10. The assembly unit 20 may extend across the key button 10 in a direction. The assembly unit 20 may have a thin plate shape. For example, the assembly unit 20 and the button holder 13 may be formed as a single body.

If the assembly unit 20 is assembled with the guide panel 30 of FIG. 1, the key button 10 including the assembly unit 20 may be combined to the guide panel 30 in such a manner that the key button 10 can slide within the assembly hole 30′ in the guide panel 30. For example, the guide panel 30 may include a guide slot (not shown) into which the assembly unit 20 is inserted, and the guide slot may guide sliding of the key button 10.

The assembly unit 20 covers the assembly hole 30′ in the guide panel 30. The assembly hole 30′ is formed to be long according to sliding of the key button 10 and the assembly unit 20 covers the assembly hole 30′, thereby preventing external foreign substances from entering inside the button assembly and helping improve the external appearance of the button assembly.

Referring to FIGS. 1 to 3, the key button 10 moves while sliding between the first to third positions P1 to P3, which are adjacent to the first to third contact point switches SW1, SW2, and SW3, respectively, thereby operating the first to third contact point switches SW1, SW2, and SW3. The first to third contact point switches SW1, SW2, and SW3 may function as a power button, a play button, and a shutter-release button, respectively, and may be turned on or off by the key button 10.

Referring to FIG. 1, the first position P1 in the assembly hole 30′ is a position at which power is turned off. If a user slides the key button 10 away from the first position P1, the first contact point switch SW1 is pressed and operates to turn power on, and the key button 10 moves to the third position P3 in the assembly hole 30′ as illustrated in FIG. 3. The third position P3 in the assembly hole 30′ is a position at which power is turned on and at which the third contact point switch SW3, which may function as a shutter-release button, may be operated in order to perform a shooting operation when a user presses the key button 10. Referring to FIG. 2, the second position P2 in the assembly hole 30′ is a temporary position at which the user presses the key button 10 to operate the second contact point switch SW2, which may function as a play button. As illustrated in FIG. 3, when the user ends the pressing of the key button 10, the key button 10 immediately returns back to its prior configuration at the third position P3 in the assembly hole 30′ due to an elastic restitution force.

The operation of an exemplary button assembly through user manipulation will now be described in detail. Referring to FIGS. 1 to 3, the key button 10 is moved from the first position P1 toward the second position P2 within the assembly hole 30′ through user manipulation. Then, the key button 10 slides to contact the moving part 111 of the first linkage device 110. The key button 10 slides along some of the inclined planes 111a, contacts peak portions 111b of the moving parts 111, and presses the moving part 111 downward. Then, the first linkage device 110 is bent downward with respect to the fixed end thereof, and the pressing part 115 of the first linkage device 110 presses the first contact point switch SW1 to turn on the first contact point switch SW1. When the contact point switch SW1, which functions as a power button, is turned on, driving power is supplied to a digital camera. Also, as illustrated in FIG. 3, when the key button 10 passes the peak portions 111b and contacts the other inclined planes 111a of the inclined moving part 111, the key button 10 is moved to the third position P3 in the assembly hole 30′ along the inclined planes 111a due to an elastic restitution force of the first linkage device 110. Then, the pressing part 115 of the first linkage device 110 is separated from the first contact point switch SW1 and returns upward to its original position.

Referring to FIGS. 1 to 3, if the key button 10 is pressed to return back to the first position P1 from the third position P3 in the assembly hole 30′, then the key button 10 slides to contact the moving part 111 of the first linkage device 110. The key button 10 slides along some of the inclined planes 111a of the moving part 111 to contact the peak portions 111b of the moving part 111, and then presses the moving part 111 downward. In this case, the first linkage device 110 is bent downward with respect to the fixed end thereof, and the pressing part 115 of the first linkage device 110 presses the first contact point switch SW1, thus turning off the first contact pint switch SW1. Also, as illustrated in FIG. 1, the key button 10 passes the peak portions 111b and contacts the other inclined planes 111a of the moving part 111, and then is moved to the first position P1 in the assembly hole 30′ along the other inclined planes 111a due to an elastic restitution force of the first linkage device 110. Then, the pressing part 115 of the first linkage device 110 is separated from the first contact point switch SW1 and returns upward to the original position.

Referring to FIG. 2, when a user slides the key button 10 from the third position P3 to the second position P2 in the assembly hole 30′, the key button 10 slides to contact the second linkage device 120. That is, the key button 10 slides along the inclined plane 121a of the moving part 121 and presses the second linkage device 120 downward, and then, the second linkage device 120 is bent downward with respect to the fixed end thereof. Next, the pressing part 125 of the second linkage device 120 presses the second contact point switch SW2 to turn on the second contact point switch SW2. For example, if the second contact point switch SW2, which may function as a play switch, is turned on, an image reproduced may be displayed. As illustrated in FIG. 3, if a user ends pressing of the key button 10, then the key button 10 is moved to the third position P3 in the assembly hole 30′ along the inclined plane 121a due to an elastic restitution force of the second linkage device 120, and the pressing part 125 of the second linkage device 120 is separated from the second contact point switch SW2 and returns upward to its original position.

If the key button 10 is then moved to the second position P2 from the third position P3 in the assembly hole 30′ through user manipulation, the key button 10 slides to contact the second linkage device 120 and then turns on the second contact point switch SW2, for example, in order to end a reproduction operation. If the user ends the manipulation, the key button 10 is moved to the third position P3 in the assembly hole 30′ along the inclined plane 121a due to an elastic restitution force of the second linkage device 120.

Referring to FIG. 3, the key button 10 is located above the third contact point switch SW3 at the third position P3 in the assembly hole 30′. The user may turn on the third contact point switch SW3 by pressing the key button 10. If the third contact point switch SW3, which may function as a shutter-release button, is turned on, the digital camera may perform a shooting operation. The key button 10 may be used as a push button that presses the third contact point switch SW3 by delivering external pressure to the third contact point switch SW3, separates from the third contact point switch SW3, and returns upward to the original position due to elastic restitution force when the external pressure has ended.

FIG. 8 is a block diagram illustrating overall construction of a digital camera according to an embodiment of the present invention. Referring to FIG. 8, the digital camera includes an optical unit 210, an imaging device 220, an analog front end (AFE) circuit 230, a digital signal processor 250, a recording medium 270, and a memory 280. The optical unit 210 includes a plurality of optical lenses to focus an image of a subject on an imaging surface of the imaging device 220. The imaging device 220 converts the image of a subject received from the optical unit 210 into an electrical image signal. The AFE circuit 230 processes and converts the electrical image signal received from the imaging 220 into a digital image signal. The memory 280 may be a dynamic random access memory (DRAM) that temporarily stores an image signal in order to provide a working space for image processing. The recording medium 270 stores image data of a subject in the form of a still image or in the form of a moving picture file. The digital signal processor 250 controls the overall flow of data and the other elements. The digital camera also includes a user input unit 251 having the button assembly as shown in FIGS. 1 to 3.

The optical unit 210 includes a zoom lens 212 that changes a focal length while moving backward and forward along an optical axis, a shutter 214 and an aperture 216 that control an exposure time and the amount of light incident on the imaging device 220, respectively, and a focus lens 218 that adjusts the focus of an image of a subject on the imaging device 220. The zoom lens 212, the shutter 214, the aperture 216, and the focus lens 218 may be driven by an actuating motor (not shown) controlled by a driver 211.

The imaging device 220 is, for example, a charged-coupled device (CCD) or a complementary metal oxide semiconductor (CMOS) image sensor, and converts an image of a subject that is incident on the imaging device 220 via the optical unit 210 into an electrical image signal. The operation of the imaging device 220 may be controlled by the digital signal processor 250 via a timing generator (TG) 221.

The AFE circuit 230 converts an analog image signal received from the imaging device 220 into a digital image signal by performing corrected double sampling (CDS) and analog digital conversion (ADC) on a signal received from the imaging device 220. The digital image signal is quantized, delivered to an encoder/decoder 260, encoded according to a predetermined compression method, and then is stored in the recording medium 270. The memory 280 provides a working space for the encoder/decoder 260 and the digital signal processor 250 to perform data processing.

The digital signal processor 250 overall controls the elements of the digital camera by executing a program recorded on an electronically erasable and programmable read-only memory (EEPROM) 265, and also performs various processes. The digital signal processor 250 performs a specific function or stops an operation that is being performed in response to a manipulation signal sensed via the user input unit 251. The user input unit 251 may include the button assembly as shown in FIGS. 1 to 3. Referring to FIGS. 1 to 3, when a user presses or slides the key button 10, an electrical path may be formed in one of the first to third contact point switches SW1, SW2, and SW3 included in the button assembly, thereby generating a switching signal. In this case, switching signals being generated by the first to third contact point switches SW1, SW2, and SW3, respectively, are supplied to the digital signal processor 250. For example, the digital signal processor 250 may sense the switching signal generated by the first contact point switch SW1 and may supply driving power or discontinue supply of power. The digital signal processor 250 senses the switching signal generated by the second contact point switch SW2 and performs or ends a reproduction operation. The digital signal processor 250 senses the switching signal generated by the third contact point switch SW3 and performs a shooting operation.

In this disclosure, a digital camera indicates any digital mobile device having a photographing operation and is not limited to cameras categorized according to shape. That is, the digital camera should be understood as various digital devices, such as camcorders, mobile phones, and personal digital assistants (PDAs), which are portable and have a photographing operation.

The button assembly and a digital camera having the same according to an embodiment of the present invention provide one integrated button that replaces a plurality of buttons and allow various switching signals to be generated by simply pressing or sliding the button. For example, a power button, a shutter-release button, and a play button, which are closely related to one another in terms of user manipulation, are implemented as one integrated button, thereby allowing for ease in performing an associated set of operations assigned to these buttons. For example, if urgent photographing is needed, it is possible to manipulate a shutter-release button right after a power button is turned on and a play button may then be manipulated after photographing is completed so that an image captured can be immediately checked. Thus, a user is capable of performing a plurality of operations that are associated with one another without having to lift a finger from the integrated button, thereby greatly improving the user's convenience in terms of manipulation.

Also, since a plurality of button functions are integrated into one button, it is possible to reduce the number of elements necessary for button assembly and the number of assembly processes, thereby saving manufacturing costs. Also, it is possible to simplify the exterior of a camera and manufacture the camera to be thinner by saving space accommodated by a large number of buttons.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

It will be recognized that the terms “comprising,” “including,” and “having,” as used herein, are specifically intended to be read as open-ended terms of art. The use of the terms “a” and “and” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

What is claimed is:

1. A button assembly for a camera, comprising:
a key button;
a first contact point switch that generates a switching signal according to sliding of the key button; and
a third contact point switch that generates a switching signal according to pressing of the key button.

2. The button assembly of claim 1, further comprising a first linkage device that is disposed between the key button and the first contact point switch and converts sliding of the key button into pressing of the first contact point switch.

3. The button assembly of claim 2, wherein the first linkage device comprises:
a moving part comprising inclined planes on which the key button slides, and which is pressed downward when the key button slides; and
a pressing part that presses the first contact switch while the moving part is pressed.

4. The button assembly of claim 1, wherein the key button slides to be moved from a first position to a second position, and
the first contact point switch is disposed adjacent to the first position.

5. The button assembly of claim 4, further comprising a second contact point switch that generates a switching signal according to sliding of the key button, the second contact point switch being disposed adjacent to the second position.

6. The button assembly of claim 5, further comprising a second linkage device that is disposed between the key button and the second contact point switch and converts sliding of the key button into pressing of the second contact point switch.

7. The button assembly of claim 6, wherein the second linkage device comprises:
a moving part comprising an inclined plane on which the key button slides, and which is pressed downward when the key button slides; and
a pressing part that presses the second contact point switch while the moving part is pressed.

8. The button assembly of claim 5, wherein the third contact point switch is disposed between the first and second contact point switches.

9. The button assembly of claim 5, wherein the first, second, and third contact point switches function as a power button, a play button, and a shutter-release button, respectively.

10. The button assembly of claim 1, wherein the key button comprises:
a button unit that is pressed by a user;
an elastic body that forces the button unit to be elastically biased upward; and
a protrusion pin that extends from the button unit and presses the third contact point switch when the user presses the button unit.

11. The button assembly of claim 1, wherein an assembly unit extends on opposite sides of the key button to cover an assembly hole formed along a direction in which the key button slides.

12. A button assembly for a camera, comprising:
a key button;
a guide panel that guides sliding of the key button and defines movement of the key button from a first position to a second position;
first and second contact point switches that are disposed adjacent to the first and second positions, respectively, and that generate a switching signal according to sliding of the key button; and
a third contact point switch that is disposed between the first and second contact point switches, and that generates a switching signal according to pressing of the key button.

13. The button assembly of claim 12, further comprising a first linkage device that is disposed between the key button and the first contact point switch and converts sliding of the key button into pressing of the first contact point switch.

14. The button assembly of claim 12, further comprising a second linkage device that is disposed between the key button and the second contact point switch and converts sliding of the key button into pressing of the second contact point switch.

15. The button assembly of claim 12, wherein the key button comprises:
a button unit that is pressed by a user;
an elastic body that forces the button unit to be elastically biased upward; and
a protrusion pin that extends from the button unit and presses the third contact point switch when the user presses the button unit.

16. A digital camera comprising:
a key button;
a guide panel that guides sliding of the key button and defines movement of the key button from a first position to a second position;
first and second contact point switches that are disposed adjacent to the first and second positions, respectively, and that generate a switching signal according to sliding of the key button; and
a third contact point switch that is disposed between the first and second contact point switches, and that generates a switching signal according to pressing of the key button.

17. The digital camera of claim 16, further comprising a digital signal processor that controls an associated set of operations being respectively linked to the first, second, and third contact point switches, in response to the switching signals.

18. The digital camera of claim 16, further comprising a first linkage device that is disposed between the key button and the first contact point switch and converts sliding of the key button into pressing of the first contact point switch.

19. The digital camera of claim 16, further comprising a second linkage device that is disposed between the key button and the second contact point switch and converts sliding of the key button into pressing of the second contact point switch.

20. The digital camera of claim 16, wherein the key button comprises:
a button unit that is pressed by a user;
an elastic body that forces the button unit to be elastically biased upward; and
a protrusion pin that extends from the button unit and presses the third contact point switch when the user presses the button unit.
